(19) United States
(12) Patent Application Publication
(10) Pub. No.: US 2021/0074187 A1
(43) Pub. Date: Mar. 11, 2021

(54) ROTATING CANTILEVER POST

(71) Applicants: JAMES OLIVER, ASCOT (AU); BOLLE BORKOWSKY, WAVELL HEIGHTS (AU)

(72) Inventors: JAMES OLIVER, ASCOT (AU); BOLLE BORKOWSKY, WAVELL HEIGHTS (AU)

(21) Appl. No.: 17/100,183

(22) Filed: Nov. 20, 2020

Related U.S. Application Data
(63) Continuation of application No. 16/236,904, filed on Dec. 31, 2018, now abandoned.
Application No. 16/236,904 is a continuation of application No. 15/729,049, filed on Oct. 10, 2017, now abandoned.
Application No. 15/729,049 is a continuation of application No. 13/877,340, filed on Apr. 2, 2013, now abandoned.

(30) Foreign Application Priority Data
Oct. 7, 2010 (AU) 2010904484

(51) Int. Cl. G09F 7/20; E01F 9/696; F16C 11/10; E04H 12/18; F16C 11/04

(52) U.S. Cl. CPC G09F 7/20; E01F 9/696; F16C 11/10; F16C 2362/00; F16C 11/04; Y10T 403/32254; E04H 12/18

(57) ABSTRACT

A swivel mechanism for a rotating cantilever post including a cantilever boom and a post, the swivel mechanism comprising at least one first gear associated with the cantilever boom and at least one second gear rotatably mounted to the post, wherein the at least one second gear is operatively associated with the at least one first gear such that rotation of the at least one second gear causes rotation of the at least one first gear, rotating the cantilever boom relative to the post.

### RELATED APPLICATION

This application is a continuation of U.S. application Ser. No. 16/236,904, filed Dec. 31, 2018, which is a continuation of U.S. application Ser. No. 15/729,049, filed Oct. 10, 2017, which is a continuation of U.S. application Ser. No. 13/877,340, filed Apr. 2, 2013, entitled “ROTATING CANTILEVER POST,” which is a National Stage Entry of PCT Patent Application No. PCT/AU2011/001287, filed Oct. 7, 2011, which claims priority to Australian Patent Application No. 2010904484, filed Oct. 7, 2010, the entire contents of which are hereby incorporated by reference.

### FIELD OF THE INVENTION

The present invention relates to a rotating cantilever post. In some embodiments, the invention is directed to a swivel mechanism for a rotating cantilever post, although the scope of the invention is not necessarily limited thereto.

### BACKGROUND

Variable speed limit (VSL) signs are used across the country in conjunction with intelligent transportation systems to lower posted speed limits in areas affected by conditions such as congestion, construction, accidents, and bad weather. VSL signs allow main roads operators to adjust the posted speed limit without changing the permanent sign. Studies have shown that the use of variable speed limit signs have the potential to provide significant benefits in terms of efficient traffic flow and road safety improvements

Existing variable speed limit sign systems currently in use on main roads are attached to overhead fixed posts. Typically, the variable speed limit display is mounted to an arm that extends across the roadway and is spaced above the roadway. A problem with existing variable speed limit sign systems is that when VSL signs are installed, undergo repair or require maintenance, roads around the VSL posts are required to be closed to allow safe access to the signs. As well as inconveniencing motorists and creating additional traffic congestion, these road closures can be costly.

It is an aim of the invention to provide a rotating cantilever post which overcomes or ameliorates one or more of the disadvantages or problems described above, or which at least provides the consumer with a useful or commercial choice.

It will be clearly understood that any reference herein to background material or information, or to a prior publication, does not constitute an admission that any material, information or publication forms part of the common general knowledge in the art, or is otherwise admissible prior art, whether in Australia or in any other country.

### DESCRIPTION OF THE INVENTION

In a first aspect, the present invention provides an apparatus for supporting a sign or the like, the apparatus comprising a post and an arm having a portion extending away from a longitudinal axis of the post, and drive means operable to cause the arm to rotate relative to the post.

In one embodiment, the arm comprises a cantilever boom. The arm may comprise a first portion that extends in a vertical direction and a second portion extends away from the first portion. The second portion of the arm may extend generally horizontally. The second portion of the arm may extend both upwardly and horizontally. The second portion of the arm may extend both downwardly and horizontally.

In one embodiment, the arm is rotatably mounted to the post.

In preferred embodiments of the present invention, the arm can only be rotated upon actuation of the driving means. In this manner, unwanted rotation of the arm relative to the post, for example, due to wind loads, can be avoided.

In one embodiment of the present invention, the drive means comprises a drive gear operatively associated with one of the post or the arm and a driven gear operatively associated with the other of the post or the arm.

It would be appreciated that other driving means may also be used.

In one embodiment, the arm can be rotated through 180° relative to the post in either direction. This effectively allows the arm to be rotated through 360°.

In one embodiment, the arm will be substantially tubular. Alternatively the arm may be of any appropriate shape. The arm may also be a cantilever boom or a cantilever beam. However, no particular limitation should be placed on the invention by the shape of the arm. The arm may comprise at least one bracket on which at least one sign may be mounted. Alternatively signs may be mounted directly to the arm. Preferably the arm is adapted to mount a VSLS. However, the arm is not limited to VSLS mounting, it may accommodate any sign including but not limited to: traffic signals, message boards, tri message signs and other signage which requires accessibility. The arm may be adapted to mount other devices such speed cameras, safety cameras, monitoring devices, lighting, transmission equipment and/or the like.

The arm may be provided with an elbow section such that the arm may be rotatably mounted relative to the post. Preferably, the arm is adapted to be rotatably mounted at least partially in the post. Alternatively, the arm may be formed with or engages with a mounting such that the arm is rotatably mounted relative to the post. In use, the arm usually extends over a part of a roadway and/or the like in a first position (typically, an in-use position) and is rotatable to a second position where the arm, brackets, signs and or the like may be accessed. The arm is typically mounted such that the arm is rotatable about a substantially vertical axis. Alternatively, the arm may be mounted such that arm is rotatable about a skewed, oblique or substantially horizontal axis such that the arm, which usually extends at a sufficient height above a roadway when in a first position, can be rotated to a second position where a substantial part of the arm is lower relative to the position of the cantilever boom in the first position. Such a rotation about a skewed, oblique or substantially horizontal axis may allow easier access to the arm, brackets, signs and or the like.

The arm may also comprise a double ended boom. The double ended boom may be bifurcated. For example, the double ended boom may be such that the apparatus for supporting a sign or the like may be substantially ‘T’ or ‘Y’ shaped. Usually, a rotating cantilever post with a double ended boom would be mounted to a centre median of a roadway and/or the like such that a part of each end section of the cantilever boom extends over a part of the roadway and/or the like in a first position.

The arm is preferably associated with at least one first gear such that rotation of the at least one first gear rotates the cantilever boom.

In another embodiment, a bushing may engage with the arm at and/or near where the arm is rotatably mounted to the post. The bushing is preferably operatively associated with another bushing that engages with the post. Alternatively the bushing may be operatively associated with the post. Normally the bushing or bushings provide for a smooth rotation of the arm relative to the post. The bushing or bushings are normally made of a suitable material, such as a nylon material. Alternatively the bushing or bushings may be made from an alloy, plastic, polymer, ceramic, composite and/or any material according to a suitable materials selection chart. No particular limitation should be placed on the invention by the type and number of bushings used, other means to achieve the same results are envisaged including the use of bearings, surface coatings and/or other means known in the art.

In one embodiment, the post may be provided with at least one slot and tabs towards the top of the post. The tabs are typically formed with or engage with the post. The slot is typically provided in the post between the tabs (e.g. the tabs are located on either side of the slot) to enable the tabs to be squeezed or “pinched” together. At least one pinch bolt is normally mounted in the tabs such that the at least one pinch bolt can squeeze or “pinch” the tabs together such that the post can clamp onto the arm or a bushing or the like, locking it in place. The post is typically formed with or engages with a footing or is mounted to a footing. The footing is usually mounted to a foundation and/or the like. Preferably the post is suitably mounted such that the post extends in a generally vertical orientation.

In another embodiment, the apparatus may be provided with a braking means. The braking means may be used in controlling the swiveling of the arm relative to the post.

In one embodiment, the arm may be provided with at least one braking surface. Typically the at least one braking surface extends from an axis of the arm. A clamping means may be associated with the post. Normally the clamping means is mounted to the post. The clamping means is typically adapted to clamp onto the at least one braking surface to lock the arm in place relative to the post. Alternatively the at least one braking surface may be associated with the post and the clamping means may be associated with the arm. It will be appreciated that the at least one braking surface may be provided on the drive gear, the driven gear and/or a flange attached to the post or arm. Alternatively, the at least one braking surface may be provided on a brake disc, rotor and/or the like. The braking surface may be provided with at least one stop to limit the rotation of the arm relative to the post. Typically the brake disc, rotor and/or the like is associated with the arm or post and the clamping means is associated with the other of the arm or post. The clamping means is typically adapted to be operated by a user. For example a locking bolt or actuator may be operable by a user to cause the clamping means to clamp or unclamp the at least one braking surface. In a preferred embodiment the clamping means may be a caliper. However, other means to achieve the same results are envisaged including the use of brake pads, locking bolts, friction material and/or the like.

In another embodiment, the apparatus may include one or more driven gears. The at least one driven gear, may be a helical gear, worm gear, spur gear, crown gear, cog, chain and sprocket, toothed device and/or the like. The axis of at least one of the at least one driven gear is usually the axis of rotation of the boom. At least one of the at least one driven gear is typically formed with or engages with the arm.

In one embodiment, the at least one drive gear is typically rotatably mounted to the post by brackets. The at least one drive gear is preferably operatively associated with the at least one driven gear such that rotation of the at least one drive gear causes rotation of the at least one driven gear. The at least one drive gear may have at least one drive portion so that the at least one drive gear may be rotated by rotating the at least one drive portion. The at least one drive portion is typically formed with or engages with the at least one drive gear The at least one drive portion may be a Phillips-, slot-, square-, Robertson-, hex-, hex socket-, torx-, security torx-, spline-, spline drive- one way-, poly drive-head and or the like. No particular limitation should be placed on the invention by the type of drive portion used. The at least one drive portion may be operated with standard spanner, socket, screw driver, ratchet, power tool, specialised tool and/or the like. Alternatively, the at least one drive gear can be driven by a motor. If the at least one drive gear is driven by a motor it may be electrically, hydraulically, pneumatically powered and/or the like, this can avoid the requirement for maintenance crew to access the at least one drive gear. The at least one drive gear and the at least one driven gear may be housed in one or more housings to protect the gears from the elements.

The at least one drive gear may be and/or include a worm. The worm may be a left handed or a right handed worm. The at least one drive gear and the at least one driven gear may be at least one self locking worm-and-gear set. Usually in a self locking worm-and-gear set, the worm can always drive the gear, however, the gear cannot drive the worm, as the gear's teeth will simply lock against the worm's teeth, because the force component circumferential to the worm is not sufficient to overcome friction. This embodiment of the present invention is particularly useful because it ensures that rotation of the arm only occurs when the worm is driven, thereby avoiding unwanted rotation of the arm due to wind forces or the like.

In another embodiment, at least one stop may be applied to the post or to the arm to limit the range of rotation of the arm relative to the post. Normally, the at least one stop is applied between the arm and the post. Preferably, the at least one stop is formed with or engages with the at least one drive gear and/or the at least one driven gear. Alternatively this may be a physical stop applied to the pivot or boom supported by the static part of the post.

The major components of the apparatus of the present invention are normally made of a suitable galvanised steel or stainless steel. Alternatively the components of the apparatus of the present invention may be made from an alloy, plastic, polymer, ceramic, composite and/or any material according to a suitable materials selection chart.

In a second aspect, the present invention provides a swivel mechanism for a rotating cantilever post including a cantilever boom and a post, the swivel mechanism comprising;

at least one first gear associated with the cantilever boom; and
at least one second gear rotatably mounted to the post;
wherein the at least one second gear is operatively associated with the at least one first gear such that rotation of the at least one second gear causes rotation of the at least one first gear, rotating the cantilever boom relative to the post. Alternatively, the at least one second gear is operatively associated with the at least one first gear such that rotation of the at least one first gear causes rotation of the at least one second gear relative to the first gear, rotating the cantilever boom relative to the post.

In a further aspect, the present invention provides a method for rotating an arm for supporting a sign or the like relative to a post, the method comprising the steps of: providing drive means adapted to rotate the arm relative to the post; and

operating the drive means to cause the arm to rotate relative to the post.

Some benefits of embodiments of the apparatus of the present invention may include the following:
1. Construction simplification;
2. Reduced costs;
3. Durability;
4. Ease of assembly;
5. Ease of installation;
6. Ability to operate under most conditions;
7. Safer and easier operation;
8. An overall reduction in costs.

### BRIEF DESCRIPTION OF THE DRAWINGS

One or more preferred embodiments of the invention will now be described, by way of example only, with reference to the accompanying drawings in which:

FIG. 1 is an isometric view of a rotating cantilever post.

FIG. 2 is a front view of a rotating cantilever post.

FIG. 3 is a detailed view of a swivel mechanism for a rotating cantilever post.

FIG. 4 is a detailed view of a bushing for a rotating cantilever post.

FIG. 5 is a top view of a rotating cantilever post.

FIG. 6 is an isometric view of a rotating cantilever post.

FIG. 7 is a detailed view of the swivel mechanism of FIG. 6.

### DETAILED DESCRIPTION OF THE DRAWINGS

It will be appreciated that the drawings have been provided for the purposes of illustrating preferred embodiments of the present invention. Therefore, it will be understood that the invention should not be considered to be limited solely to the features as shown in the attached drawings.

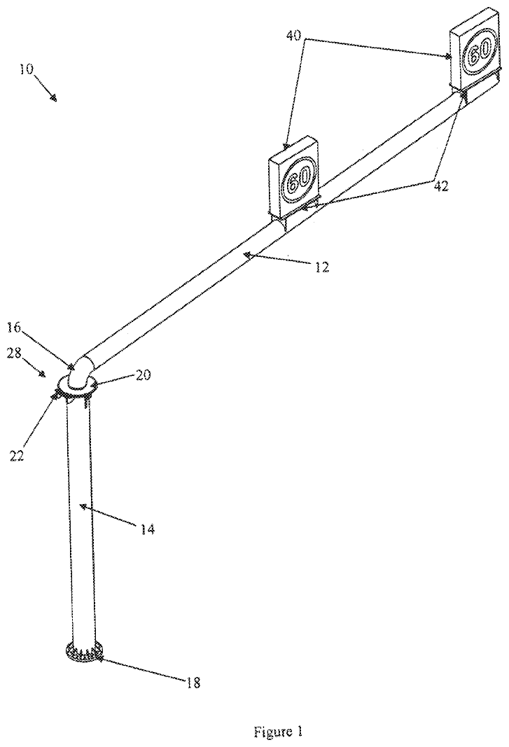

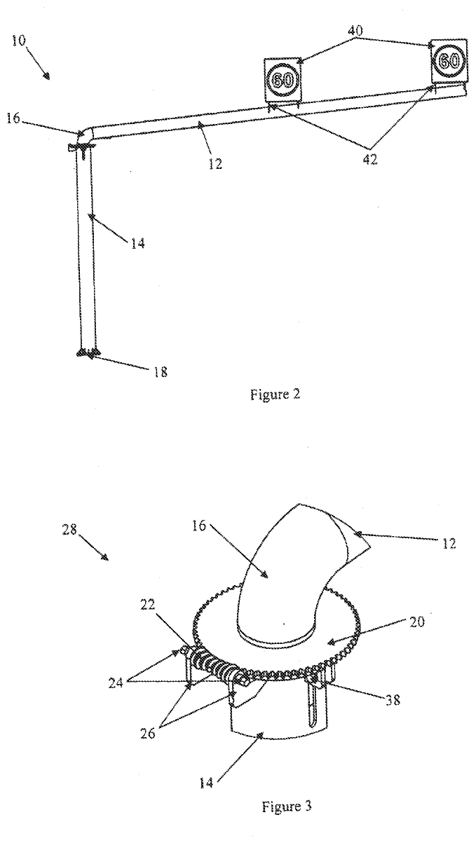

With reference to FIGS. 1-2, an apparatus in accordance with an embodiment of the present invention is shown in the form of a rotating cantilever post 10. The rotating cantilever post 10 has an arm in the form of a cantilever boom 12. Brackets 42 enable signs 40 to be mounted to the cantilever boom 12. The cantilever boom 12 has an elbow section 16 and extends into a post 14. The post 14 has a footing 18 which is mounted to a foundation (not shown). A driven gear in the form of a gear 20 is attached to the cantilever boom 12. A swivel mechanism 28 that enables the cantilever boom 12 to be rotated relative to the post 14 comprises a drive gear in the form of a worm 22 operatively associated with the gear 20.

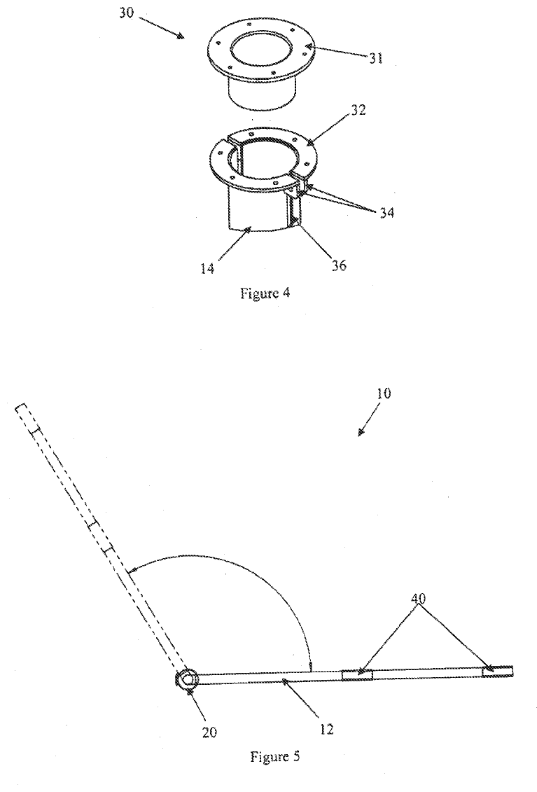

FIGS. 3 and 4 show the swivel mechanism 28 in detail. The worm 22 is rotatably mounted to the post 14 by brackets 26. Projections 24 on the worm 22 allow a tool (not shown), such as a spanner, ratchet, power tool or the like to turn the worm 22. The projections 24 form the drive portion. When the worm 22 is not being turned, the cantilever boom 12 is locked in position as the gear 20 cannot drive the worm 22. In this regard, the worm screw 20 comprises a self locking worm screw.

A bushing 30 is attached to the cantilever boom 12 and inserted into the post 14 such that bushing flange 31 sits on top of flange 32. The bushing 30 is attached to the cantilever boom 12 such that the cantilever boom 12 cannot rotate relative to the bushing (e.g. by a friction fit). Gear 20 is positioned above the flange 31 of the bushing 30. The post 14 has a slot 36 and tabs 34 located on either side of the slot 36. Pinch bolts 38 are mounted in the tabs 34 such that the pinch bolts 38 can squeeze or “pinch” the tabs 34 together such that the top part of the post 14 clamps onto the bushing 30, providing additional locking of the cantilever boom 12.

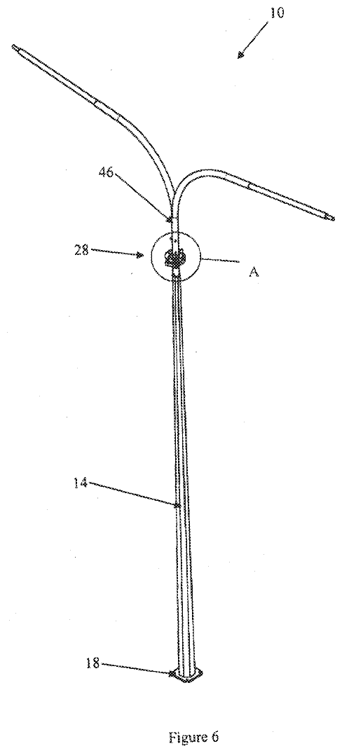

With reference to FIGS. 3 - 5, when the rotating cantilever post 10 is in use, the cantilever boom 12 is in a first position (see FIG. 5, solid lines), usually over a roadway (not shown). In this position, the bushing 30 is usually locked in position by pinch bolts 38 as described above and the gear 20 is locked in position by the worm 22. When the cantilever boom 12 has to be rotated to access the signs 40, it for maintenance for example, the pinch bolts 38 are loosened so that the bushing 30 is no longer locked in position by the top of the post, at least one of the projections 24 on the worm 22 is turned in a first direction using a tool (not shown), thus turning the gear 20 and rotating the cantilever boom 12 into a second position (see FIG. 5, dashed lines as an example), where the signs 40 can be safely accessed. Once the maintenance, for example, has been performed, the worm gear is turned in a second direction using a tool (not shown), thus turning the gear 20 and rotating the cantilever boom 12 back to the first position (see FIG. 5, solid lines). Alternatively, the worm 22 can be turned in the first direction until the cantilever boom 12 (see FIG. 5, solid lines) has rotated to the first position. Once the cantilever boom 12 is in the first position, the worm 22 automatically locks gear 20 in position as it is no longer being turned, the pinch bolts 38 are tightened, locking the bushing 30 and the cantilever boom 12 in position.

With reference to FIG. 6, an apparatus in accordance with an embodiment of the present invention is shown in the form of a rotating cantilever post 10. The rotating cantilever post 10 has an arm in the form of a double ended boom 46. The post 14 is mounted to a foundation (not shown) by the footing 18. The swivel mechanism 28 enables the double ended boom 46 to be rotated relative to the post 14.

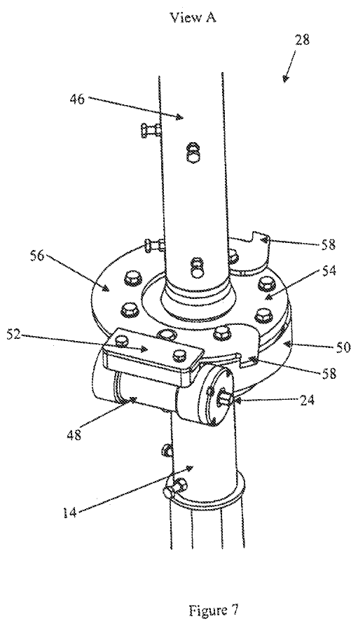

With reference to FIG. 7, the swivel mechanism 28 of FIG. 6 is shown in detail. The double ended boom 46 is rotatably mounted to the post 14. The worm (not shown) is partially encased by a worm housing 48 which is mounted relative to the post 14. The gear (not shown) is partially encased by a gear housing 50 which is mounted relative to the post 14. The projection 24 extends from the worm housing such that a tool (not shown), such as a spanner, ratchet, power tool or the like can turn the worm (not shown). A flange 54 is attached to the double ended boom 46. A brake disc 56 is attached to the flange 54. A clamping means in the form of a caliper 52 is mounted relative to the post 14. The caliper 52 is adapted to clamp onto the brake disc 56 to lock the double ended boom 46 relative to the post 14. The brake disc 56 is provided with two stops 58 such that the rotation of the double ended boom 46 relative to the post 14 is limited by the stops 58 abutting the caliper 52.

The foregoing embodiments are illustrative only of the principles of the invention, and various modifications and changes will readily occur to those skilled in the art. The invention is capable of being practiced and carried out in various ways and in other embodiments. It is also to be understood that the terminology employed herein is for the purpose of description and should not be regarded as limiting.

In the present specification and claims (if any), the word “comprising” and its derivatives including “comprises” and “comprise” include each of the stated integers but does not exclude the inclusion of one or more further integers.

Reference throughout this specification to “one embodiment”, or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A cantilever post comprising:
a cantilever boom, a fixed post, and a swivel mechanism, the swivel mechanism comprising;
at least one first gear associated with one of the cantilever boom and the fixed post; and
at least one second gear associated with the other of the cantilever boom and the fixed post;
wherein the at least one second gear is operatively associated with the at least one first gear such that rotation of the at least one second gear causes rotation of the at least one first gear, causing rotation of the cantilever boom relative to the fixed post during use; and
wherein the at least one first gear and the at least one second gear comprise a self locking gear set,
the mechanism further comprising
a braking surface associated with one of the fixed post or the cantilever boom,
a clamping surface associated with the other of the fixed post or the cantilever boom during use,
the clamping surface being adapted to clamp onto the braking surface, the braking surface being provided with two spaced stop members abutting the clamping surface whereby during use rotation of the cantilever boom relative to the post is limited by the two stop members abutting the clamping surface.

2. The cantilever post as claimed in claim 1, wherein during use the at least one second gear is rotatably mounted to the post.

3. The cantilever post as claimed in claim 1, wherein the at least one second gear is a worm gear.

4. The cantilever post as claimed in claim 1, wherein the cantilever boom rotates about a substantially vertical axis.

5. The cantilever post as claimed in claim 1, wherein at least one sign is mounted relative to the cantilever boom.

6. An apparatus for supporting a sign, the apparatus comprising a fixed post and an arm having a portion extending away from a longitudinal axis of the post, and a drive means operable to cause the arm to rotate relative to the fixed post, wherein the drive means comprises:
a drive gear operatively associated with one of the fixed post or the arm; and
a driven gear operatively associated with the other of the fixed post or the arm;
wherein the drive gear and the driven gear comprise a self locking gear set,
the apparatus further comprising a braking surface associated with one of the fixed post or the arm, a clamping surface associated with the other of the fixed post or the arm, the clamping surface being adapted to clamp onto the braking surface, the braking surface being provided with two stop members abutting the clamping surface whereby rotation of the arm relative to the fixed post is limited by the two stop members abutting the clamping surface.

7. The apparatus as claimed in claim 6, wherein the drive gear is a worm gear.

8. The apparatus as claimed in claim 6, wherein the rotation of the arm relative to the fixed post occurs only as a result of rotation of the drive gear.

9. The apparatus as claimed in claim 6, wherein the drive gear is driven by a motor.

10. The apparatus as claimed in claim 6, wherein the arm rotates about a substantially vertical axis.

11. The apparatus as claimed in claim 6, wherein the arm comprises a double ended boom.

12. The apparatus as claimed in any one of claim 6, further comprising at least one bushing at least partially located between the post and the arm.
